(19) United States
(12) Patent Application Publication
(10) Pub. No.: US 2017/0374324 A1
(43) Pub. Date: Dec. 28, 2017

(54) VEHICLE WITH EVENT RECORDING

(71) Applicant: Ford Global Technologies, LLC, Dearborn, MI (US)

(72) Inventor: Michael Edward Loftus, Northville, MI (US)

(21) Appl. No.: 15/193,975

(22) Filed: Jun. 27, 2016

(51) Int. Cl. H04N 7/18; G08G 1/017

(52) U.S. Cl. CPC H04N 7/188; G08G 1/0175

(57) ABSTRACT

A vehicle including: sensors, processor(s) configured to: make a primary detection; list objects located within a calculated focus area; mark the listed objects as partially identified or fully identified; estimate velocities of the partially identified objects; select connected vehicles based on the estimated velocities; instruct the connected vehicles to: record the partially identified objects, electronically deliver the recordings to an address.

### TECHNICAL FIELD

This disclosure relates to motor vehicles with sensors.

### BACKGROUND

Vehicles include a range of sensors, which are capable of sensing data. A need exists to collect and organize this sensed data.

### SUMMARY

A vehicle consistent with the disclosure includes: sensors, processor(s) configured to: make a primary detection; list objects located within a calculated focus area; mark the listed objects as partially identified or fully identified; estimate velocities of the partially identified objects; select connected vehicles based on the estimated velocities; instruct the connected vehicles to: record the partially identified objects, electronically deliver the recordings to an address.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a block diagram of a vehicle computing system.

FIG. 2 is a schematic of a vehicle including the vehicle computing system.

FIG. 3 is a top view of a town.

FIG. 4 illustrates a noise identification.

FIG. 5 is a block diagram of method corresponding to noise identification.

FIG. 6 is a top view of a home.

FIG. 7 is a block diagram of a first part of a method of identifying objects.

FIG. 8 is a block diagram of a second part of the method of identifying objects.

FIG. 9 is a top view of a vehicle and a virtual focus area.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present, as one option, and mutually exclusive alternatives as another option. In other words, the conjunction “or” should be understood to include “and/or” as one option and “either/or” as another option.

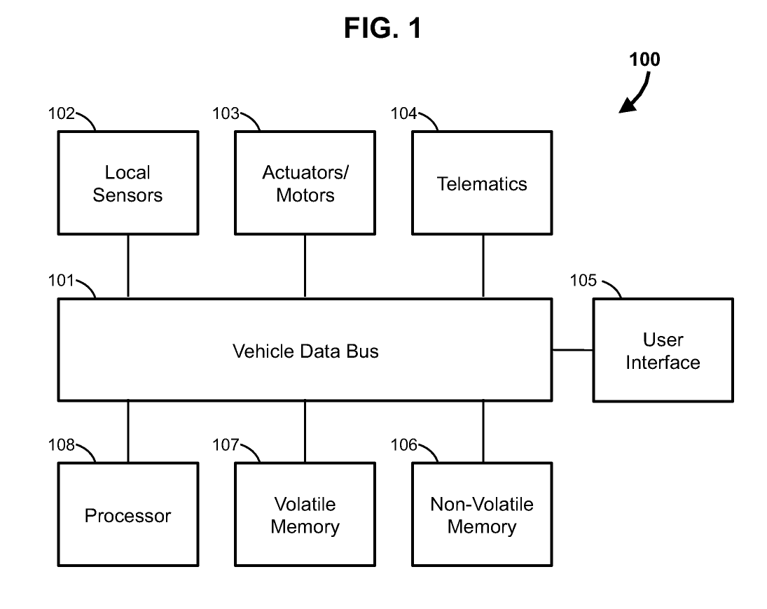

FIG. 1 shows a computing system 100 of an example vehicle 200. The vehicle 200 is also referred to as a first vehicle 200. The vehicle 200 includes a motor, a battery, at least one wheel driven by the motor, and a steering system configured to turn the at least one wheel about an axis. Suitable vehicles are also described, for example, in U.S. patent application Ser. No. 14/991,496 to Miller et al. (“Miller”) and U.S. Pat. No. 8,180,547 to Prasad et al. (“Prasad”), both of which are hereby incorporated by reference in their entireties. The computing system 100 enables automatic control of mechanical systems within the device. It also enables communication with external devices. The computing system 100 includes a data bus 101, one or more processors 108, volatile memory 107, non-volatile memory 106, user interfaces 105, a telematics unit 104, actuators and motors 103, and local sensors 102.

The term “loaded vehicle,” when used in the claims, is hereby defined to mean: “a vehicle including: a motor, a plurality of wheels, a power source, and a steering system; wherein the motor transmits torque to at least one of the plurality of wheels, thereby driving the at least one of the plurality of wheels; wherein the power source supplies energy to the motor; and wherein the steering system is configured to steer at least one of the plurality of wheels.” The term “equipped electric vehicle,” when used in the claims, is hereby defined to mean “a vehicle including: a battery, a plurality of wheels, a motor, a steering system; wherein the motor transmits torque to at least one of the plurality of wheels, thereby driving the at least one of the plurality of wheels; wherein the battery is rechargeable and is configured to supply electric energy to the motor, thereby driving the motor; and wherein the steering system is configured to steer at least one of the plurality of wheels.”

The data bus 101 traffics electronic signals or data between the electronic components. The processor 108 performs operations on the electronic signals or data to produce modified electronic signals or data. The volatile memory 107 stores data for immediate recall by the processor 108. The non-volatile memory 106 stores data for recall to the volatile memory 107 and/or the processor 108. The non-volatile memory 106 includes a range of non-volatile memories including hard drives, SSDs, DVDs, Blu-Rays, etc. The user interface 105 includes displays, touch-screen displays, keyboards, buttons, and other devices that enable user interaction with the computing system. The telematics unit 104 enables both wired and wireless communication with external processors via Bluetooth, cellular data (e.g., 3G, LTE), USB, etc. The telematics unit 104 may be configured to broadcast signals at a certain frequency (e.g., one type of vehicle to vehicle transmission at 1 kHz or 200 kHz, depending on calculations described below). The actuators/motors 103 produce physical results. Examples of actuators/motors include fuel injectors, windshield wipers, brake light circuits, transmissions, airbags, haptic motors or engines etc. The local sensors 102 transmit digital readings or measurements to the processor 108. Examples of suitable sensors include temperature sensors, rotation sensors, seatbelt sensors, speed sensors, cameras, lidar sensors, radar sensors, etc. It should be appreciated that the various connected components of FIG. 1 may include separate or dedicated processors and memory. Further detail of the structure and operations of the computing system 100 is described, for example, in Miller and/or Prasad.

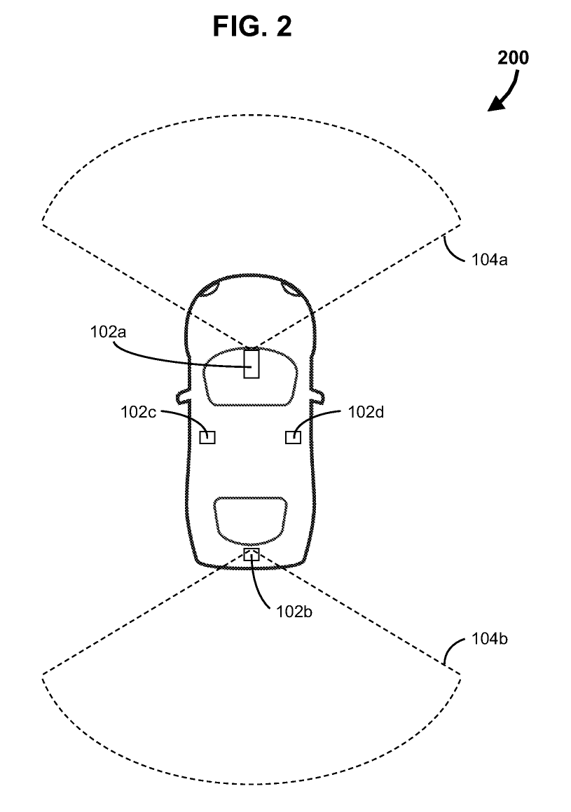

FIG. 2 generally shows and illustrates the vehicle 200, which includes the computing system 100. Although not shown, the vehicle 200 is in operative wireless communication with a nomadic device, such as a mobile phone. Some of the local sensors 102 are mounted on the exterior of the vehicle 200. Local sensor 102a may be an ultrasonic sensor, a lidar sensor, a camera, a video camera, and/or a microphone, etc. Local sensor 102a may be configured to detect objects leading the vehicle 200 as indicated by leading sensing range 104a. Local sensor 102b may be an ultrasonic sensor, a lidar sensor, a camera, a video camera, and/or a microphone, etc. Local sensor 102b may be configured to detect objects trailing the vehicle 200 as indicated by leading sensing range 104b. Left sensor 102c and right sensor 102d may be configured to perform the same functions for the left and right sides of the vehicle 200. The vehicle 200 includes a host of other sensors 102 located in the vehicle interior or on the vehicle exterior. These sensors may include any or all of the sensors disclosed in Prasad.

It should be appreciated that the vehicle 200 is configured to perform the methods and operations described below. In some cases, the vehicle 200 is configured to perform these functions via computer programs stored on the volatile and/or non-volatile memories of the computing system 100. A processor is “configured to” perform a disclosed operation when the processor is in operative communication with memory storing a software program with code or instructions embodying the disclosed operation. Further description of how the processor, memories, and programs cooperate appears in Prasad. It should be appreciated that the nomadic device or an external server in operative communication with the vehicle 200 perform some or all of the methods and operations discussed below.

According to various embodiments, the vehicle 200 is the vehicle 100a of Prasad. In various embodiments, the computing system 100 is the VCCS 102 of FIG. 2 of Prasad. In various embodiments, the vehicle 200 is in communication with some or all of the devices shown in FIG. 1 of Prasad, including the nomadic device 110, the communication tower 116, the telecom network 118, the Internet 120, and the data processing center 122.

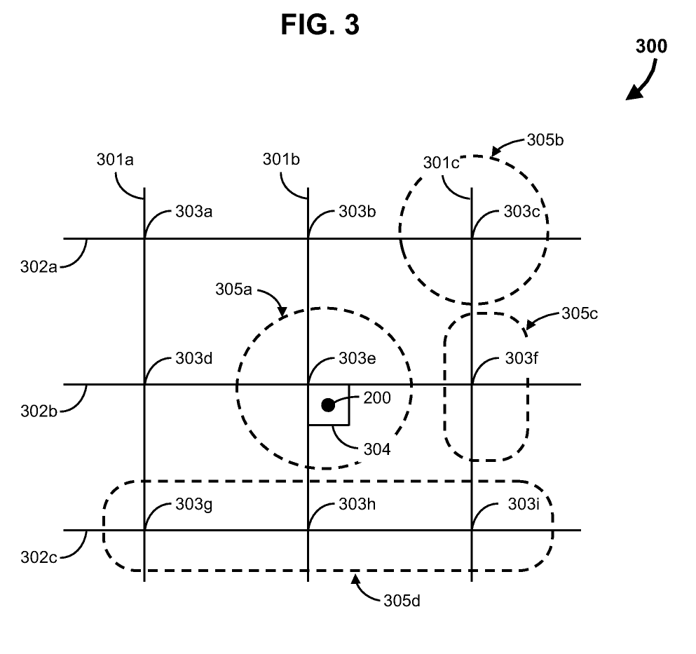

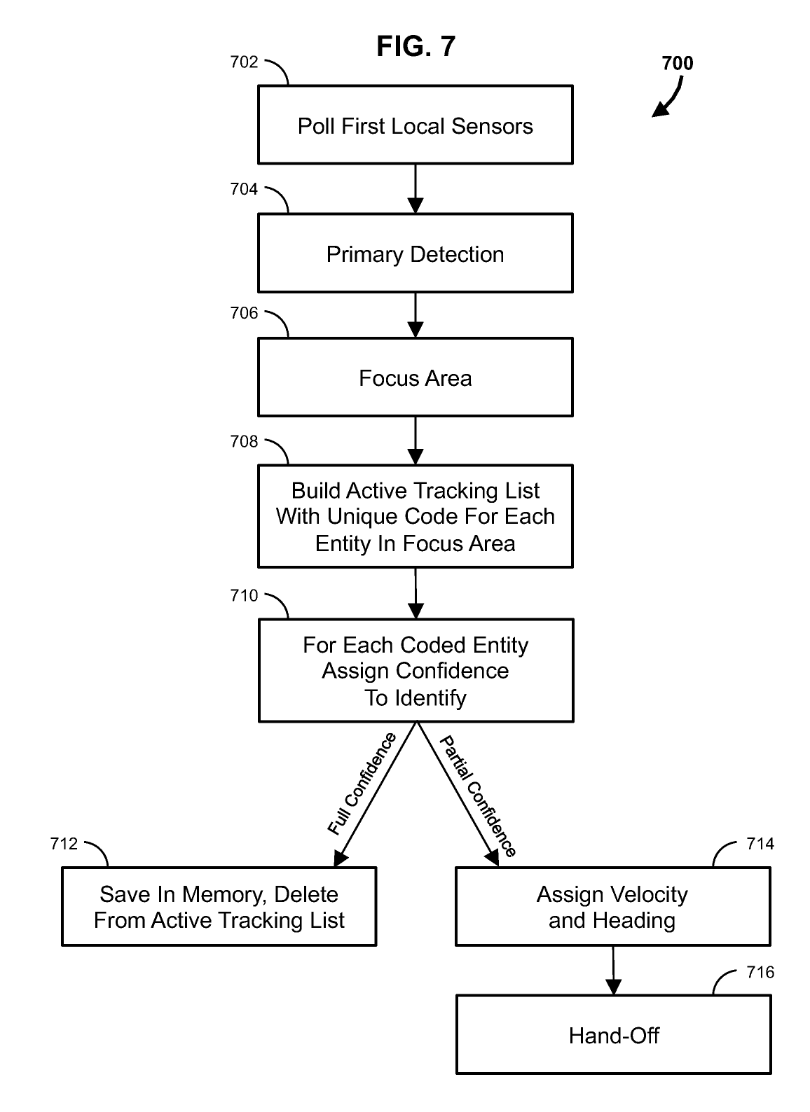

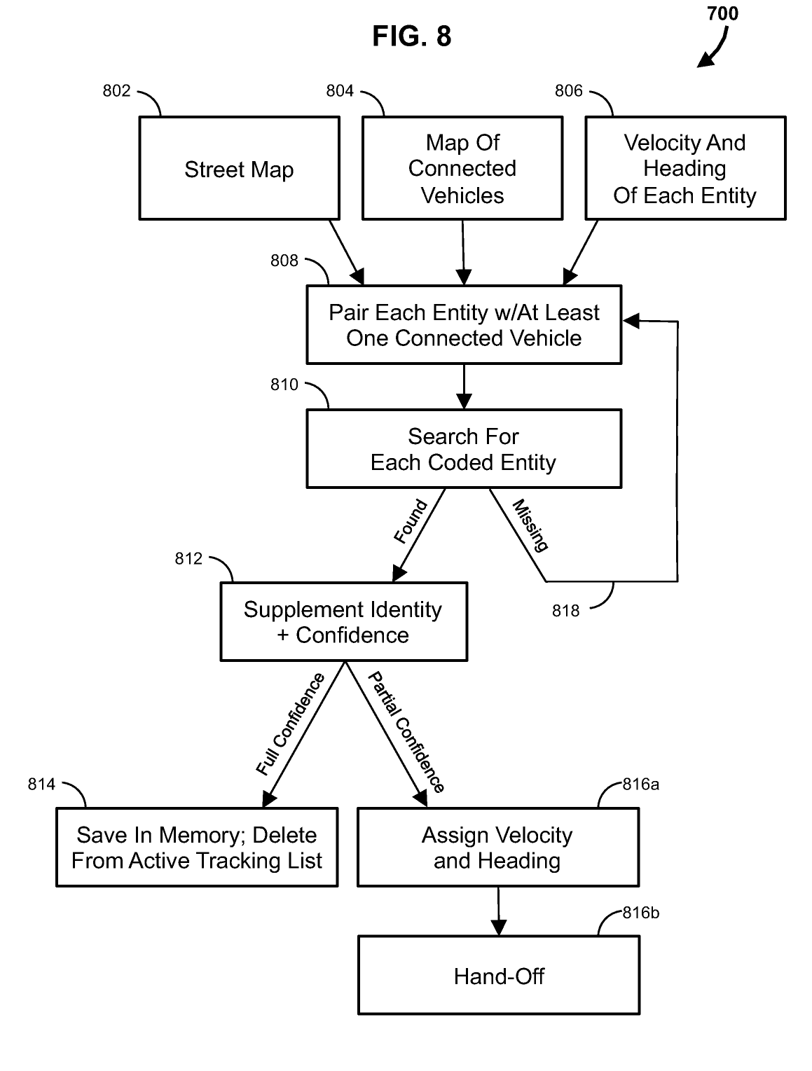

FIG. 3 generally shows and illustrates a town 300 including north/south roads 301a, 301b, 301c, east/west roads 302a, 302b, 302c, and a parking lot 304. The roads 301, 302 intersect at nodes (i.e., intersections) 303a, 303b, 303c, 303d, 303e, 303f, 303g, 303g and 303i. The vehicle 200 is configured to detect an event (e.g., a break-in or a hit-and-run), and then initiate or coordinate a search based on the detection. FIGS. 7 and 8, which are discussed in detail below, generally show and illustrate a method 700 for performing such a search. FIG. 8 generally shows and illustrates additional details of block 716 of the method 700 of FIG. 7.

With reference to FIG. 3, the vehicle 200 is stopped in the parking lot 304. The vehicle 200 detects an event such as the break-in or the hit-and-run. The vehicle 200 detects such an event via the local vehicle sensors 102. For example, accelerometers may detect a sudden acceleration of the vehicle consistent with an impact; sensors connected to the vehicle doors and/or windows may detect a breakage of a window or an unauthorized opening of a door. This kind of detection is referred to as a primary detection and is generally identified via first local vehicle sensors that perpetually run when the vehicle 200 is parked and/or off. The vehicle 200 may be configured to accept a user-input via the user interface 105 commanding the vehicle 200 to make the primary detection.

With reference to FIG. 7, the vehicle 200 periodically polls the first local sensors at block 702. The vehicle further evaluates the polls at block 702 by comparing the content of the polls to predetermined values. When one or more of the polls exceeds an associated predetermined value, the vehicle confirms a primary detection at block 704.

Once the primary detection occurs at block 704, the vehicle 200 is configured to apply information extracted from second local vehicle sensors to generate a composite of the event. Many people and/or vehicles may surround the vehicle 200. Therefore, according to various embodiments, the vehicle 200 estimates an original time of the event, then tracks people and/or vehicles within a radius of the vehicle 200, the radius being based on (a) the original time of the event and (b) time elapsed since the original time.

Additionally, according to various embodiments, the vehicle 200 identifies a side of the vehicle 200 associated with the event via the first local vehicle sensors. If, for example, an acceleration sensor on the left side of the vehicle 200 measured acceleration prior to the right side of the vehicle, then the vehicle 200 may assume that the event originated on the left side of the vehicle 200. If a window is broken, then the vehicle 200 may identify the location of the broken window and then focus on the side corresponding to the broken window.

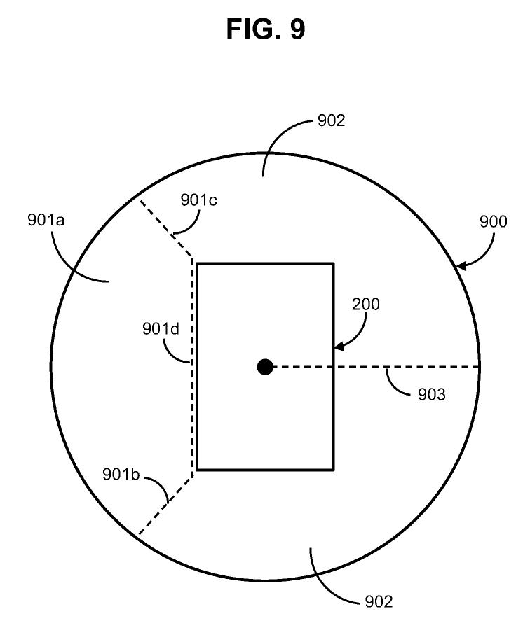

With reference to FIG. 9, according to various embodiments, the vehicle 200 combines the radius with the identified side to select a portion of the circular area defined by the radius. As shown in FIG. 9, the vehicle 200 has determined a radius 903 based on (a) the original time of the event and (b) the time elapsed since the original time, and defined a circle 900 given the radius. As shown in FIG. 9, the vehicle 200 has determined that the event originated on the left side of the vehicle. The vehicle thus discards portion 902 of the circle 900 and sets portion 901a of the circle 900 as the focus area. Portion 901a of the circle 900 includes boundaries 901b, 901c, and 901d. Boundaries 901b and 901c may be radial. Boundary 901d may track the surface of the left side of the vehicle. It should thus be appreciated that the focus area may resemble a trapezoid with a curved base. If a side cannot be identified, then the entire circle 900 defined by the radius 903 is the focus area.

Returning to block 708 of FIG. 7, the vehicle 200 counts each person and external vehicle (collectively referred to as “objects”) within the focus area. More specifically, the vehicle 200 builds an active tracking list and assigns a unique code to each object on the tracking list. The unique code organizes information contributed from multiple sources. Block 708 is further explained below.

With reference to block 708, build the active tracking list, the vehicle 200 scans the surroundings with second local vehicle sensors. The second local vehicle sensors may be cameras. According to various embodiments, the second local vehicle sensors automatically turn off or deactivate when the vehicle is parked and/or turned off and are thus reactivated by the vehicle 200 at block 708.

With reference to block 708, the vehicle 200 applies known image filtering software to identify people and external vehicles (collectively “objects”) within the focus area. The vehicle 200 identifies external vehicles by their make, model, color, and/or license plate. The vehicle 200 identifies people with facial recognition technology, and/or technology that applies image recognition software to approximate, height, weight, skin-tone, hair color, etc.

With reference to block 708, each identified vehicle or person is assigned a separate entry in the active tracking list. After block 708, the vehicle 200 has generated an active tracking list that has, for each counted object in the focus area: a unique and randomly generated ID, a type of the object (e.g., vehicle or person), and detected characteristics of the object (e.g., make, model, hair color, eye color, height, etc.).

At block 710, the vehicle 200 reviews the information (i.e., the detected characteristics) associated with each object and assigns a confidence to an identity of the object based on the reviewed information. The confidence is based on a quality of the identification. For external vehicles, the vehicle 200 may assign a full confidence only when it has captured a suitable (e.g., non-blurred) image of the license plate such that the vehicle 200 can read (via OCR technology) each individual character of the license plate. For people, the vehicle 200 may assign a full confidence only when a predetermined level of facial recognition has been achieved.

The vehicle 200 thus, at block 710, marks each object in the active tracking list as having a full confidence identity (i.e., being fully identified) or a partial or incomplete confidence identity (i.e., being partially identified). When an object has been identified with full confidence, the vehicle 200 no longer tracks the object. Accordingly, in block 712, the vehicle 200 stores the identity of the object and removes the object from the active tracking list. When an object has not been identified with full confidence, the vehicle 200 is configured to collect additional information on the object.

The method 700 proceeds to block 714 when the vehicle 200 has partial or incomplete confidence in one of the identities. At block 714, the vehicle 200 assigns a velocity (which includes a speed and heading) to the object. The vehicle 200 performs block 714 in anticipation of the object departing from the sensing range of the local sensors 102. At block 716, the vehicle 200 hands-off tracking of the object to other connected vehicles. According to various embodiments, the vehicle 200 perpetually cycles steps 708, 710, and 714 for a partially identified object until the object is (a) identified with full confidence (i.e., fully identified), or (b) has departed from the sensing range of the local vehicle sensors 102 (i.e., until the local sensors 102 of the vehicle 200 can no longer resolve the object).

FIG. 8 generally shows and illustrates the handing-off process 716. The vehicle 200 accesses a street map at block 802, a map showing current locations of connected vehicles (i.e., vehicles configured to contribute tracking information) at block 804, and the velocity and heading information for each partially identified object at block 806. The maps of blocks 802 and 804 may be the same map. At block 808, the vehicle 200 pairs or associates each partially identified object with at least one connected vehicle based on the information accessed in blocks 802, 804, and 806.

More specifically, and with reference to FIG. 3, the vehicle 200 builds, for each partially identified object, a supplementary search zone 305. FIG. 3 includes four example supplementary search zones 305a, 305b, 305c, and 305d. The vehicle 200 builds each supplementary search zone 305 based on the street map, the map of connected vehicles, and velocity and heading of each partially identified object.

More specifically, the vehicle 200 assesses the velocity and heading information for each partially identified object and, based on the velocity and heading, predicts the next node that the object will enter. For example, a partially identified object may have been last observed heading toward node 303h from parking lot 304. The vehicle 200 generates a time window that the object will arrive at the predicted node (e.g., node 303h). The vehicle 200, with reference to the map of connected vehicles, finds connected vehicles 200 expected to simultaneously occupy the node (e.g., node 303h) during the time window.

If no connected vehicles are projected to simultaneously occupy the predicted node with the object, then the vehicle 200 expands the supplementary search zone to encompass nodes adjacent to the predicted node. For example, if the supplementary search zone 305d initially only encompassed node 303h, then it could be expanded to encompass nodes 303g and 303i, as shown in FIG. 3. The vehicle 200 recruits connected vehicles for each node within the expanded search zone by repeating the above-described processes. According to various embodiments, newly encompassed nodes may be selected with a formula that assumes the partially identified object will not turn around (i.e., the expanded search zone 305d would not cover node 303e).

Returning to FIG. 8, the selected connected vehicles search for each partially identified object at block 810. The selected connected vehicles search for objects matching the description existing in the active tracking list. If connected vehicles locate an object matching the existing description, then the connected vehicles supplement the active tracking list with newly recorded information at block 812.

The vehicle 200 reviews the supplementary information and determines whether the object has been fully identified. If the supplementary information has resulted in a full identification, then the vehicle 200 removes the object from the active tracking list at block 814. If the supplementary information has not resulted in a full confidence identification, then the vehicle 200 determines velocity and heading of the partially identified object based on information supplied by the connected vehicles at block 816a and hands-off tracking of the partially identified object at block 816b. A hand-off at block 816b causes the vehicle 200 to repeat the process of FIG. 8.

If the partially identified object was not found in the supplementary search zone, then the method proceeds to 818 where the vehicle 200 pairs the partially identified object with new connected vehicles by returning to block 808. As previously discussed, when the vehicle 200 returns to block 808, the vehicle 200 expands the supplementary search zone to encompass additional nodes.

It should be appreciated that although the above steps have been described as being coordinated by the vehicle 200, some or all of the steps may be coordinated by a different computer, such as an external server in communication with the vehicle 200. More specifically, a centralized server may be configured to perform or coordinate some or all of the steps. The vehicle 200 and the connected vehicles may be in operative communication with the centralized server and supply the centralized server with sensor readings, etc.

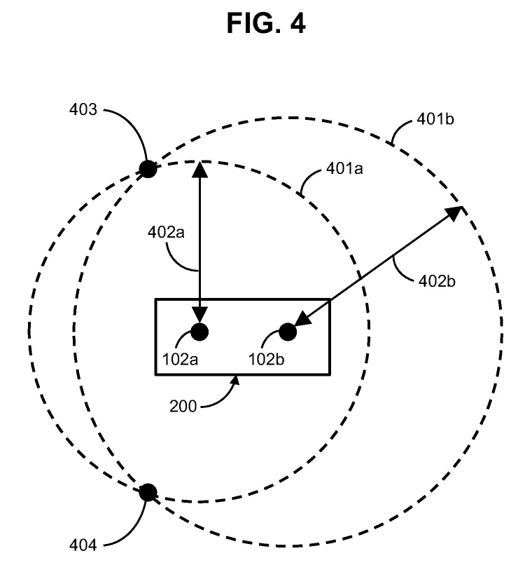

FIG. 4 generally shows and illustrates a use case of a noise identification strategy that can be performed by the vehicle 200. The vehicle 200 may be configured to perform the noise identification strategy in addition to the methods of FIGS. 7 and 8. The vehicle 200 applies the noise identification strategy to identify an origin of a unique noise, such as a gunshot. In FIG. 4, local sensors 102a and 102b include microphones configured to record sound.

The vehicle 200 performs the noise identification strategy. Each of the local sensors 102a and 102b transmit signals representative of recorded sound to the computing system 100. The computing system 100 identifies discrete noises within the recorded sound. The computing system 100 may perform such an identification, for example, with a Fourier transform that deconstructs sounds into constituent frequencies. Sound may be separated into discrete noises based on the constituent frequencies of the sound (e.g., sound with a high frequencies is a first noise, whereas sound with low frequencies is a second noise).

The identification may take into account a volume of the sound or amplitude of the frequencies when separating the sound into the discrete noises. It should be appreciated that a volume of a sound or noise is based on amplitude of the constituent frequencies of the sound or noise. It should thus be appreciated that when this disclosure refers to volume, the disclosure also refers to amplitudes of the constituent frequencies.

The computing system 100 matches discrete noises recorded at local sensor 102a with discrete noises recorded at local sensor 102b. More specifically, because local sensor 102a is spaced apart from local sensor 102b, noises will arrive at one of the local sensors first and another of the local sensors later. According to various embodiments, the computing system 100 only matches discrete noises that satisfy predetermined criteria. The predetermined criteria may include one or more frequencies and one or more amplitudes or volumes (e.g., only noises with a frequency within a specific range and with a volume above a specific level are matched). According to various embodiments, the predetermined criteria are updated based on information received via the telematics 104. The received information may include weather information including information about times and locations of lightning strikes. Thus, upon receiving information about a lightning strike, the computing system 100 may adjust the predetermined criteria to exclude noises with profiles (frequencies and/or amplitudes) associated with lightning strikes.

The computing system 100 classifies a matched discrete noise based on the constituent frequencies of the discrete noise. A gunshot, for example, will generate a discrete noise with unique constituent frequencies. According to various embodiments, based on the classification, the computing system 100 estimates an origination volume of the noise. A gunshot, for example, may have produce sound with an original volume of 163 to 166 dB. It should be appreciated that the computing system 100 may apply other methods to determine an origination volume of the noise. For example, the computing system 100 may include more than two microphones and estimate an origination volume of the sound based on (a) the known distances between the microphones, (b) the constituent frequencies, and (c) attenuation of the volume or amplitudes of the noise between the microphones.

The computing system 100 builds a circular virtual fence centered around each microphone based on (a) the estimated origination volume of the noise, (b) the measured volume of the noise, and (c) the constituent frequencies of the noise. Sound or noise frequencies attenuate in a medium, such as air, at known rates with distance. Thus, if the original amplitudes of the frequencies are known, the measured amplitudes of the frequencies are known, and the attenuation rate is known, the distance can be estimated.

FIG. 4 shows a first virtual fence 401a centered around local sensor 102a and a second virtual fence 401b centered around local sensor 102b. First virtual fence 401a has a first radius 402a. Second virtual fence 401b has a second radius 102b. In this example, local sensor 102a recorded noise with a greater volume (i.e., amplitudes) than local sensor 102b. Thus, local sensor 102a is closer to the source of the noise than local sensor 102b. As a result, the first radius 402a is smaller than the second radius 402b.

The computing system 100 determines intersections of the virtual fences. In FIG. 4, the first virtual fence 401a intersects the second virtual fence 401b at intersections 403 and 404. It should be appreciated that additional microphones and additional virtual fences (e.g., a third virtual fence) may result in a single intersection.

The intersections 403 and 404 represent likely points of origination of the noise. The computing system 100 references the map of connected vehicles (see block 804 of FIG. 8 and the related disclosure). The computing system 100 selects connected vehicles within a predetermined range of the likely points of origination. The computing system 100 instructs the selected vehicles to record, store, and/or upload images of their surroundings to a centralized database. The computing system 100 instructs the selected vehicles to append the recorded, stored, and/or uploaded images with a unique identifier. The centralized database collects images with the same unique identifier and saves the collected images in a specific location. A user, such as law enforcement, may download and view the collected images.

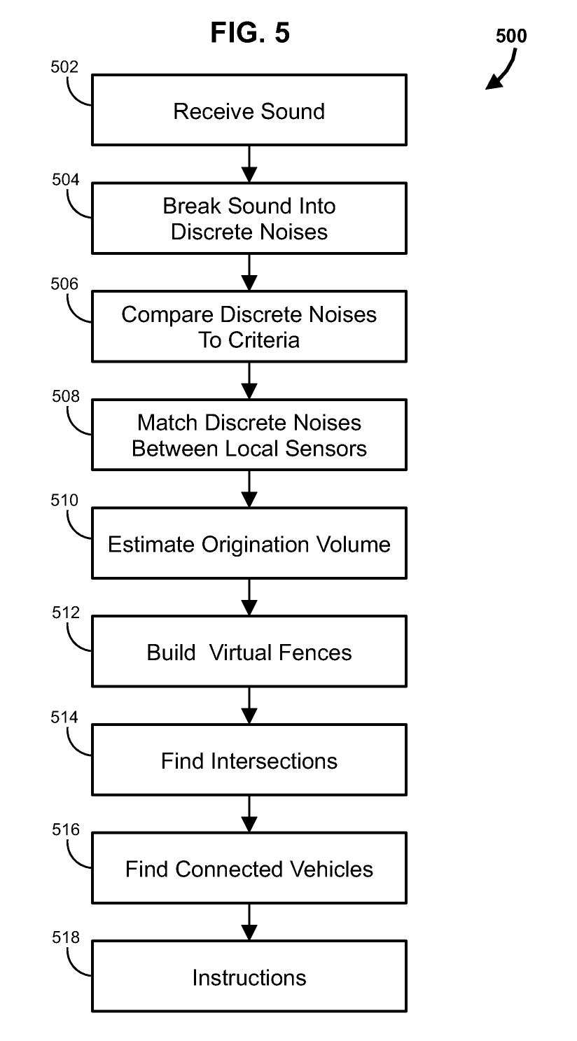

FIG. 5 generally shows and illustrates a method 500 of performing the use case identification strategy consistent with the above disclosure. According to various embodiments, the computing system 100 enables user suspension of some or all of these steps for a user-determined time span via the user interface 105. Additionally, according to various embodiments, the computing system 100 is configured to receive a third-party command (e.g., from a remote user) directing the computing system to suspend some or all of these steps. Such a feature would enable law enforcement, for example, to avoid being inundated with a flood of detections.

At block 502, the computing system 100 receives recorded sound from the local sensors 102 (i.e., the microphones). At block 504, the computing system 100 segments or breaks the recorded sound into discrete noises. At block 506, the computing system 100 compares features (e.g., frequencies and/or associated amplitudes) of each discrete noise to predetermined criteria (e.g., frequency and/or amplitude criteria). At block 508, the computing system 100 matches a discrete noise recorded at one of the local sensors 102 with discrete noises recorded at the other local sensors 102. According to various embodiments, the computing system 100 only proceeds to block 508 when a discrete noise of at least one of the local sensors 102 satisfies the predetermined criteria.

At block 510, the computing system 100 estimates an origination volume of the noise according to some or all of the previously discussed methods. At block 512, the computing system 100 builds the virtual fences (e.g., virtual fences 401a and 401b). At block 514, the computing system 100 finds one or more intersections of the virtual fences (e.g., intersections 403 and 404). At block 516, the computing system 100 references a map of connected vehicles and selects connected vehicles with a predetermined proximity of the intersections. At block 518, the computing system 100 sends instructions to (i.e., recruits) the selected connected vehicles, such as the instructions to store, record, and/or upload images. It should be appreciated that an external server may perform some or all of the blocks of FIG. 5 instead of the computing system 100.

According to various embodiments, the computing system 100 or the external server performs the above process with respect to sounds matched between distinct connected vehicles. More specifically, the computing system 100 or the external server matches noise recorded at a local sensor of a first connected vehicle with noise recorded at a local sensor of a second connected vehicle. The external server or computing system 100 then performs similar method steps with reference to the known/measured/received distance between the distinct connected vehicles. In other words, the method functions according to the above steps when local sensor 102a is mounted on a first vehicle and local sensor 102b is mounted on a second vehicle.

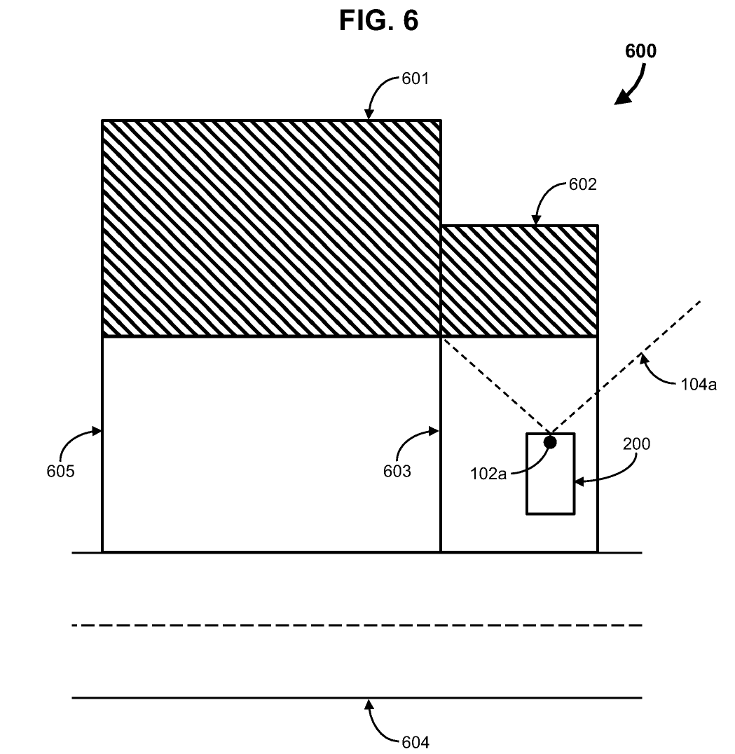

FIG. 6 generally shows and illustrates a property 600 with a house 601, a garage 602, a front lawn 605, and a driveway 603. The driveway 603 joins a road 604. The vehicle 200 is parked in the driveway. The property 600 is equipped with a home alarm or security system (not shown). When active, the security system is configured to detect opening of doors, windows, and/or the garage 602. The security system performs such detections via known security technology. As is known in the art, the security system alerts a predetermined amount of time after a detection. Upon alerting, the security system broadcasts noises, activates lights, and/or broadcasts a distress call to a third party.

The security system is configured to communicate with the vehicle 200 via the telematics 104. Upon detection and/or upon alerting, the security system, in addition to performing the above operations, instructs the vehicle 200 to (a) begin recording with the local vehicle sensors 102, (b) activate a car alarm siren, (c) activate a horn, and/or (d) flash some or all of the lights. According to various embodiments, the vehicle 200 automatically uploads measurements or recordings of the local vehicle sensors to a centralized database and/or the third party.

FIG. 6 shows local sensor 102a capturing events within sensing range 104a. According to various embodiments, the security system is configured to receive and display the captured events on a screen located inside of the house 601. According to various embodiments, the security system is configured to automatically and/or via user command, actuate the local sensor 102a to move or adjust the sensing range 104a. According to various embodiments, upon detection and/or upon alerting, the security system instructs the vehicle 200 to capture and upload 360 degree view around the vehicle 200 with the local sensors 102.

The above disclosure references a map of connected vehicles. It should be appreciated that the map of connected vehicles may include static objects with suitable sensors (e.g., a camera perched on a traffic light). It should thus be appreciated that the above-described methods may include assigning particular tracking or identification tasks to the static objects in addition to the connected vehicles (i.e., the static objects are simply treated as connected vehicles with a velocity of zero).

1. A loaded vehicle comprising:
sensors, processor(s) configured to:
make a primary detection;
list objects located within a calculated focus area;
mark the listed objects as partially identified or fully identified;
estimate velocities of the partially identified objects;
select connected vehicles based on the estimated velocities;
instruct the connected vehicles to:
record the partially identified objects, electronically
deliver the recordings to an address.

2. The vehicle of claim 1, wherein the processor(s) are configured to:
make the primary detection with a first group of the sensors, the first group of sensors being always on.

3. The vehicle of claim 1, wherein the sensors comprise a camera and the processor(s) are configured to: list the objects within the calculated focus area based on images from the camera.

4. The vehicle of claim 3, wherein the processor(s) are configured to:
disable the camera upon detecting a first event and automatically enable the camera, when the vehicle is parked, upon making the primary detection.

5. The vehicle of claim 1, wherein the list is an active tracking list and the processor(s) are configured to: upon marking one of the objects as fully identified, automatically remove said object from the active tracking list.

6. The vehicle of claim 1, wherein the processor(s) are configured to:
identify a side of the vehicle based on the primary detection, calculate the focus area based on (a) the identified side and (b) time elapsed since the primary detection.

7. The vehicle of claim 6, wherein the processor(s) are configured to:
exclude objects located outside of the calculated focus area from the list.

8. The vehicle of claim 1, wherein the processor(s) are configured to:
mark one of the objects as fully identified based on resolving, with optical character recognition software, each character of a license plate of said object.

9. The vehicle of claim 1, wherein the processor(s) are configured to:
decline to estimate velocities of fully identified objects located within the focus area.

10. The vehicle of claim 1, wherein the processor(s) are configured to:
select the connected vehicles based on received locations and velocities of the connected vehicles.

11. A method of operating a loaded vehicle that includes sensors and processor(s), the method comprising, via the processor(s):
making a primary detection;
listing objects located within a calculated focus area;
marking the listed objects as partially identified or fully identified;
estimating velocities of the partially identified objects;
selecting connected vehicles based on the estimated velocities;
instructing the connected vehicles to:
record the partially identified objects, electronically deliver the recordings to an address.

12. The method of claim 11, comprising:
making the primary detection with a first group of the sensors, the first group of sensors being always on.

13. The method of claim 11, wherein the sensors include a camera and the method comprises: listing the objects within the calculated focus area based on images from the camera.

14. The method of claim 13, comprising: disabling the camera upon detecting a first event and automatically enabling the camera, when the vehicle is parked, upon making the primary detection.

15. The method of claim 11, wherein the list is an active tracking list and the method comprises: upon marking one of the objects as fully identified, automatically removing said object from the active tracking list.

16. The method of claim 11, comprising: identifying a side of the vehicle based on the primary detection, calculating the focus area based on (a) the identified side and (b) time elapsed since the primary detection.

17. The method of claim 16, comprising: excluding objects located outside of the calculated focus area from the list.

18. The method of claim 11, comprising: marking one of the objects as fully identified based on resolving, with optical character recognition software, each character of a license plate of said object.

19. The method of claim 11, comprising: declining to estimate velocities of fully identified objects located within the focus area.

20. The method of claim 11, comprising:
selecting the connected vehicles based on received locations and velocities of the connected vehicles.
